(19) United States
(12) Patent Application Publication
(10) Pub. No.: US 2023/0395777 A1
(43) Pub. Date: Dec. 7, 2023

(54) HYBRID ANODE FOR BATTERIES AND RELATED METHODS

(71) Applicant: Teledyne Scientific & Imaging, LLC, Thousand Oaks, CA (US)

(72) Inventors: Tadej Semenic, Thousand Oaks, CA (US); Peter Malati, Hawthorne, CA (US); Kyle Gould, Los Angeles, CA (US); Avijit Bhunia, Newbury Park, CA (US)

(21) Appl. No.: 17/830,249

(22) Filed: Jun. 1, 2022

(51) Int. Cl. H01M 4/134; H01M 4/04; H01M 4/1395; H01M 4/66

(52) U.S. Cl. CPC H01M 4/134; H01M 4/0471; H01M 4/0419; H01M 4/0404; H01M 4/1395; H01M 4/0435; H01M 4/661; H01M 2004/021

(57) ABSTRACT

Techniques are provided for implementing hybrid anodes for batteries. In one example, a battery anode includes a current collector having a continuous particulate matrix and an open pore structure and an anode material disposed at least within pores of the current collector. In another example, a method of forming the anode includes forming a slurry of current collector particles, a binder, and a solvent, casting the slurry into a film, de-binding the slurry to remove the binder and solvent, sintering the particles to form a current collector, and infiltrating the current collector with an anode material.

### TECHNICAL FIELD

The present disclosure relates generally to hybrid anodes for batteries and batteries including the same.

### BACKGROUND

Many applications, such as unmanned vehicles, robots, and consumer electronics rely heavily on battery power and there is a need for high performance primary batteries. For example, certain unmanned aerial vehicles (UAVs) may require both high power density (about 1250 W/kg) for vertical takeoff and/or landing and high energy density (about 750 Wh/kg) to endure long flight times under normal operating loads. Lithium metal batteries are considered to be among the most energy-dense batteries, which makes them a suitable power source for such applications. Increasing energy density is key in battery-dependent applications where even a slight reduction in weight can yield massive improvement in performance. However, existing batteries are limited in power and energy density due to inactive material mass, such as that of the current collectors, electrolyte, and battery housing and packaging.

Solid metal current collectors generally require a minimum thickness to have sufficient strength and processability/handleability. Attempts to reduce current collector mass have included the use of mesh current collectors, foam current collectors, and etched or perforated current collectors. However, such current collectors pose several issues. For instance, these techniques weaken the current collector and the current collector therefor may need to be thicker than a comparable solid current collector. As such, the reduction in inactive material mass is rather limited as are the improvements to energy and power density. Further, these techniques may produce current collectors with nonuniform surfaces that lead to poor performance and safety issues (such as short circuits) in an anode and battery including the same. Moreover, perforated current collectors require laser ablation, which is expensive and not scalable.

### SUMMARY

Various techniques are disclosed to provide a hybrid anode and a battery including the same for use in applications such as unmanned vehicles, robots (e.g., those used in aerospace and deep space industries), and consumer electronics. The hybrid anode described herein may increase energy and power density by minimizing the mass and volume of the anode current collector leading to significant improvements in specific energy.

In one embodiment, a battery anode includes a current collector with a continuous particulate matrix and an open pore structure and an anode material disposed at least within pores of the current collector.

In another embodiment, a method includes forming a slurry with current collector particles, a binder, and a solvent, casting the slurry into a film having a thickness of less than 20 μm, de-binding to remove solvent and binder, sintering the current collector particles together to form a current collector including a continuous particulate matrix, where the particulate matrix has an open porous structure, and then infiltrating the current collector with an anode material.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a diagrammatic view of a battery in accordance with embodiments of the disclosure.

FIG. 2A is a diagrammatic view of a current collector in accordance with embodiments of the disclosure.

FIG. 2B is a diagrammatic view of an anode including the current collector of FIG. 2A in accordance with embodiments of the disclosure.

FIG. 2C is a diagrammatic view of an anode including the current collector of FIG. 2A in accordance with embodiments of the disclosure.

FIG. 2D is a diagrammatic view of an anode including the current collector of FIG. 2A in accordance with embodiments of the disclosure.

FIG. 3 illustrates a process of forming an anode and battery in accordance with embodiments of the disclosure.

Embodiments of the present invention and their advantages are best understood by referring to the detailed description that follows. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

In one or more embodiments, a hybrid anode is provided having an anode active material (referred to herein as an “anode material”) infiltrated into and extending from a porous anode current collector. In particular, the anode current collector comprises a particulate matrix formed of bonded (e.g., sintered) current collector particles that form pores therebetween. The anode current collector has an open pore structure making it permeable to the anode material. Compared to a solid current collector, the anode current collector of the present disclosure may have a density that is lower by from 30% to more than 70% and the resulting void volume of the anode current collector may be completely infiltrated with the anode material. Accordingly, the hybrid anode drastically reduces the space and mass occupied by the anode current collector, thereby increasing specific and/or volumetric capacity of the hybrid anode. Also provided herein is a battery including the hybrid anode.

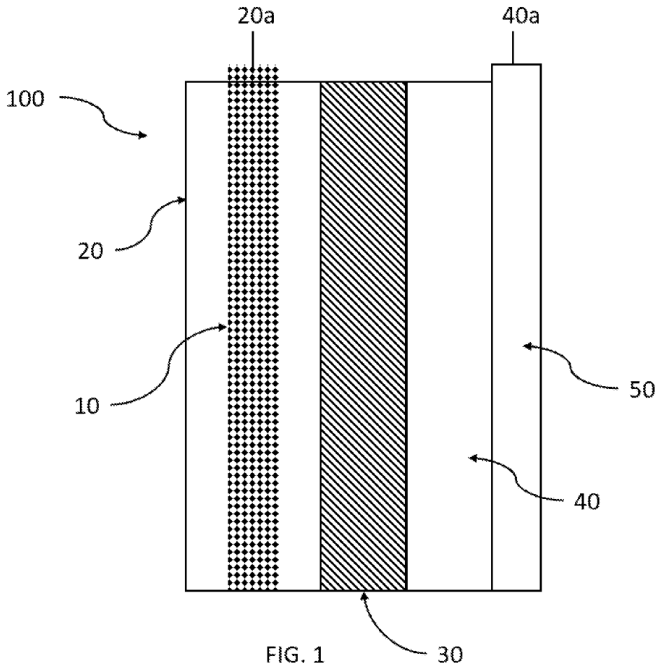

Turning to FIG. 1, a battery 100 according to embodiments of the present disclosure is depicted. In some embodiments, the battery 100 is a lithium metal battery such as a button or coin cell battery, a prismatic cell battery, a pouch cell battery, or a cylindrical cell battery.

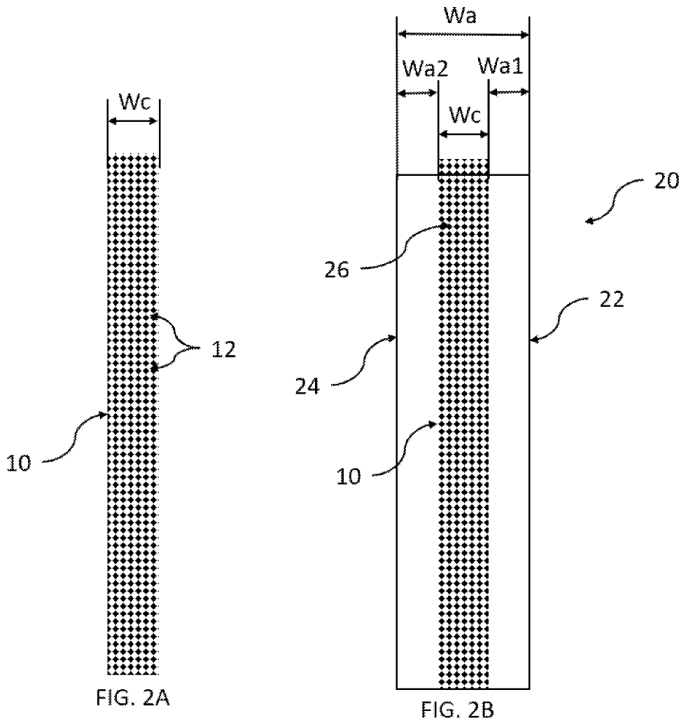

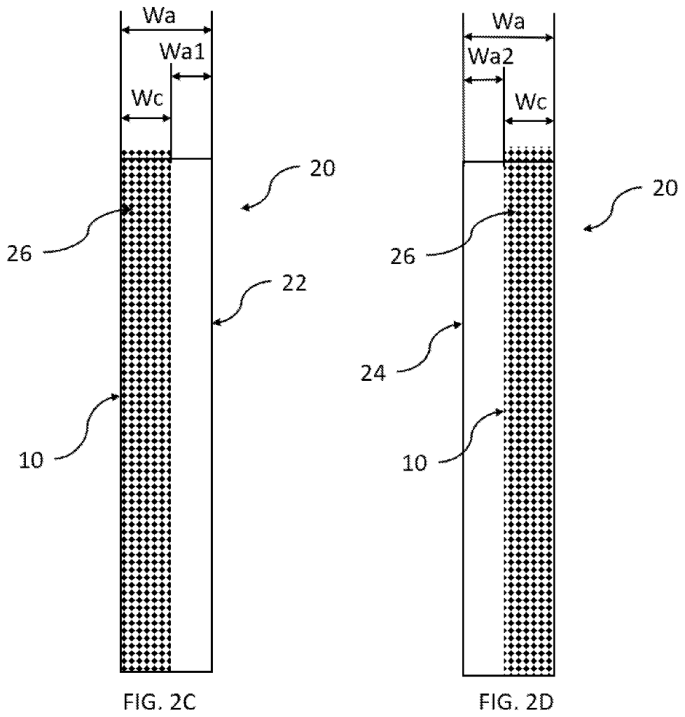

The battery 100 includes a hybrid anode 20, which includes an anode current collector 10 integrally formed therewith. The hybrid anode 20 and anode current collector 10 are described in more detail below with reference to FIGS. 2A-2D. The hybrid anode 20 includes a terminal 20a for connecting a load to the battery 100 (via the integrally formed anode current collector 10).

The battery 100 further includes a porous separator 30. The separator 30 facilitates ion transfer from the hybrid anode 20 to the cathode 40 during discharge while isolating these components to avoid a short circuit. The composition of the separator 30 is not particularly limited in the battery 100. Suitable separators 30 include any porous membrane having resistance to the internal environment of a primary lithium battery. For example, a nonwoven material formed from polymers such as polyethylene, polypropylene, and polyethylene terephthalate, ceramics materials such as glass fibers, cellophane, nylon, or combinations thereof may be used as the separator 30.

The battery 100 further includes a cathode 40 and a cathode current collector 50. The cathode 40 includes a terminal 40a for connecting a load to the battery 100 (via cathode current collector 50). The cathode 40 is not particularly limited and may include cathode active materials, binders, and additives known in the field of lithium primary batteries. For example, the cathode may include a carbon monofluoride (CFₓ) active material, a polymer binder, and a conductive carbon additive.

A liquid or solid electrolyte (not shown) may be incorporated into and/or surrounding the separator 30, hybrid anode 20, and/or cathode 40 of the battery 100 in order to facilitate ion transport across the separator 30. The electrolyte composition is not particularly limited and may include an aqueous electrolyte or a nonaqueous electrolyte, such as a polymer electrolyte. In general, electrolytes include one or more solvents and one or more salts dissolved therein. Various solvents and salts known in the field of lithium primary batteries may be used.

Turning to FIGS. 2A-2D, the anode current collector 10 and the hybrid anode 20 including the same are depicted in more detail. In particular, as shown in FIG. 2A, the anode current collector is formed of current collector particles 12 that are joined together (e.g., sintered together) to form a particulate matrix having an open porous structure. In some embodiments, the anode current collector includes no closed pores or substantially no closed pores. In some embodiments, the particulate matrix has a substantially uniform structure.

The anode current collector 10 has a thickness Wc, which may range from about 8 μm to about 12 μm. In some embodiments, the thickness Wc is at least 8 μm, at least 9 μm, or at least 10 μm. In some embodiments, the thickness Wc is less than 20 μm, less than 15 μm, less than 13 μm, less than 12 μm, less than 11 μm, or less than 10 μm. In some embodiments, the thickness Wc is from about 8 μm to about 10 μm or from about 8 μm to less than 10 μm. In one or more embodiments, the anode current collector 10 has a uniform or substantially uniform thickness Wc. That is, the thickness Wc may have a variation of less than 2 μm, less than 1.5 μm, less than 1 μm, or less than 0.5 μm.

In some embodiments, the anode current collector 10 is formed of copper, i.e., the current collector particles 12 are copper particles. Copper has high electrical conductivity and is stable at anode potential. In other embodiments, the anode current collector 10 is formed of nickel, steel, aluminum, titanium, platinum, copper, gold, or combinations thereof. In some embodiments, the current collector particles 12 are pure or substantially pure. For example, the current collector particles 12 may be at least 95 wt % pure, at least 98 wt % pure, at least 99 wt % pure, at least 99.5 wt % pure, or at least 99.9 wt % pure. In some embodiments, the current collector particles 12 have an average diameter of greater than 0.5 μm to less than 3 μm, greater than 1 μm to less than 3 μm, greater than 2 μm to less than 3 μm, about 1 μm, about 2 μm, about 3 μm, less than 3 μm, less than 2.5 μm, or less than 2 μm.

In one or more embodiments, the anode current collector 10 has a porosity of at least 30%, at least 40%, at least 50%, at least 60%, or at least 70%. In some embodiments, the porosity of the anode current collector 10 is uniform or substantially throughout. For example, the porosity may vary by less than 10%, less than 5%, less than 3%, or less than 1% throughout the anode current collector 10. In some embodiments, the pores have an average diameter of greater than 0.5 μm to less than 3 μm, greater than 1 μm to less than 3 μm, greater than 2 μm to less than 3 μm, about 1 μm, about 2 μm, about 3 μm, less than 3 μm, less than 2.5 μm, or less than 2 μm. In some embodiments, the pores are interconnected and the anode current collector is permeable.

Referring to FIGS. 2B, 2C, and 2D, the hybrid anode 20 includes the anode current collector 10, an infiltrated anode material 26 within the pores of the anode current collector 10, and a first anode layer 22 and/or a second anode layer 24 extending from one or both sides of the anode current collector 10. The first anode layer 22 and the second anode layer 24 are formed of the same material as the infiltrate anode material 26 (referred to collectively as “the anode material”). In some embodiments, the anode material is lithium metal. In other embodiments, the anode material is carbon or silicon.

In the embodiment shown in FIG. 2B, the hybrid anode 20 includes both the first anode layer 22 and the second anode layer 24. The first anode layer 22 has a thickness Wa1. In some embodiments, the thickness Wa1 is from greater than 0 μm to 100 μm, from 30 μm to 90 μm, from 50 μm to 80 μm, from 50 μm to 100 μm, at least 10 μm, at least 20 μm, at least 30 μm, at least 40 μm, at least 50 μm, at least 60 μm, at most 100 μm, at most 90 μm, at most 80 μm, at most 70 μm, at most 60 μm, at most 50 μm, at most 40 μm, at most 30 μm, about 20 μm, about 30 μm, about 40 μm, about 50 μm, or about 60 μm. In some embodiments, the thickness Wa1 is uniform or substantially uniform along the length of the hybrid anode 20. For example, the thickness Wa1 may have a variation of less than 2 μm, less than 1.5 μm, less than 1 μm, or less than 0.5 μm. In some embodiments, the first anode layer 22 is smooth or substantially smooth. For instance, the first anode layer 22 may have a surface roughness of less than 2 μm, less than 1.5 μm, less than 1 μm, less than 0.5 μm, less than 0.25 μm, or less than 0.1 μm.

The second anode layer 24 has a thickness Wa2. In some embodiments, the thickness Wa2 is from greater than 0 μm to 100 μm, from 30 μm to 90 μm, from 50 μm to 80 μm, from 50 μm to 100 μm, at least 10 μm, at least 20 μm, at least 30 μm, at least 40 μm, at least 50 μm, at least 60 μm, at most 100 μm, at most 90 μm, at most 80 μm, at most 70 μm, at most 60 μm, at most 50 μm, at most 40 μm, at most 30 μm, about 20 μm, about 30 μm, about 40 μm, about 50 μm, or about 60 μm. In some embodiments, the thickness Wa2 is uniform or substantially uniform along the length of the hybrid anode 20. For example, the thickness Wa2 may have a variation of less than 2 μm, less than 1.5 μm, less than 1 μm, or less than 0.5 μm. In some embodiments, the second anode layer 24 is smooth or substantially smooth. For instance, the second anode layer 24 may have a surface roughness of less than 2 μm, less than 1.5 μm, less than 1 μm, less than 0.5 μm, less than 0.25 μm, or less than 0.1 μm.

The hybrid anode 20 has a thickness Wa, which is a sum of the thickness of the first anode layer 22 (thickness Wa1), the anode current collector 10 (thickness Wc), and the second anode layer 24 (thickness Wa2). In some embodiments, the thickness Wa may range from about 50 μm to about 200 μm, from about 70 μm to about 150 μm, from about 70 μm to about 120 μm, or from about 90 μm to about 110 μm. In some embodiments, the thickness Wa is at least 50 μm, at least 60 μm, at least 70 μm, at least 80 μm, at least 90 μm, at least 100 μm, at least 110 μm, at least 120 μm, at least 150 μm, at most 200 μm, at most 150 μm, at most 120 μm, at most 110 μm, at most 100 μm, at most 90 μm, or at most 80 μm. In some embodiments, the thickness Wa is uniform or substantially uniform along the length of the hybrid anode 20. For example, the thickness Wa may have a variation of less than 2 μm, less than 1.5 μm, less than 1 μm, or less than 0.5 μm. In some embodiments, surfaces of the hybrid anode 20 are smooth or substantially smooth. For instance, the hybrid anode 20 may have a surface roughness of less than 2 μm, less than 1.5 μm, less than 1 μm, less than 0.5 μm, less than 0.25 μm, or less than 0.1 μm.

The infiltrated anode material 26 is present within pores (between current collector particles 12) of the anode current collector 10. In some embodiments, the infiltrated anode material completely or substantially completely fills the pores of the anode current collector 10. For example, the infiltrated anode material 26 may fill at least 90%, at least 95%, at least 98%, at least 99%, or about 100% of the void space formed by the pores of the anode current collector 10. In some embodiments, the hybrid anode 20 includes little or no void space. For example, the hybrid anode 20 may include less than 5%, less than 3%, less than 1%, or about 0% of void space. As such, energy density and power density of the hybrid anode 20 and the battery 100 may be maximized.

In the embodiment shown in FIG. 2C, the second anode layer 24 is minimal or not present. That is, in some embodiments, the hybrid anode 20 may include only the first anode layer 22. In such embodiments, a surface of the anode current collector 10 opposite the first anode layer 22 may still be coated in a thin layer of the anode material (e.g., less than 5 μm, less than 3 μm, less than 2 μm, or less than 1 μm).

In the embodiment shown in FIG. 2D, the first anode layer 22 is minimal or not present. That is, in some embodiments, the hybrid anode 20 may include only the second anode layer 24. In such embodiments, a surface of the anode current collector 10 opposite the second anode layer 24 may still be coated in a thin layer of the anode material (e.g., less than 5 μm, less than 3 μm, less than 2 μm, or less than 1 μm).

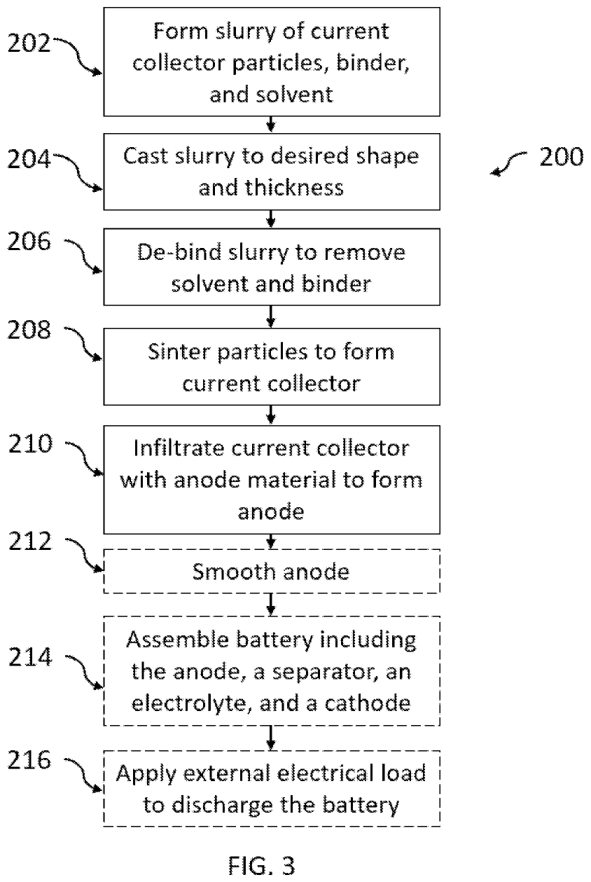

Turning to FIG. 3, a method 200 of forming the hybrid anode 20 and a battery 100 including the same is shown. Method 200 includes various steps (e.g., also referred to as blocks or operations) further discussed below. In a step 202, a slurry of current collector particles 12 is formed. The current collector particles 12 may be formed of nickel, steel, aluminum, titanium, platinum, copper, gold, or combinations thereof. In some embodiments, the current collector particles 12 are pure or substantially pure. For example, the current collector particles 12 may be at least 95 wt % pure, at least 98 wt % pure, at least 99 wt % pure, at least 99.5 wt % pure, or at least 99.9 wt % pure. In some embodiments, the current collector particles 12 have an average diameter of from greater than 0.5 μm to less than 5 μm, from greater than 0.5 μm to less than 4 μm, from greater than 1 μm to less than 3 μm, from greater than 2 μm to less than 3 μm, about 1 μm, about 2 μm, about 3 μm, less than 3 μm, less than 2.5 μm, or less than 2 μm.

In addition to the current collector particles 12, the slurry includes a binder and a solvent. The binder may include, but is not limited to, propylene glycol. The solvent may include, but is not limited to, isopropyl alcohol. In some embodiments, the slurry includes the current collector particles 12, binder, and solvent in a weight ratio of about 40:1:9. The components may be mixed together using mixing processes known to those of ordinary skill in the art, which may include, but are not limited to, hand mixing or automatic mixing using a magnetic stir plate.

In a step 204, the slurry is cast into a desired shape and thickness. In some embodiments, this step includes tape casting the slurry into a film using a doctor blade. In some embodiments, the slurry is cast into a film having a thickness of from about 8 μm to about 12 μm, at least 8 μm, at least 9 μm, at least 10 μm, less than 30 μm, less than 20 μm, less than 15 μm, less than 13 μm, less than 12 μm, less than 11 μm, less than 10 μm, from about 8 μm to about 30 μm, from about 10 μm to about 30 μm, from about 8 μm to about 20 μm, from about 8 μm to about 10 μm, or from about 8 μm to less than 10 μm. In one or more embodiments, the cast thickness is uniform or substantially uniform thickness, having a variation of less than 2 μm, less than 1.5 μm, less than 1 μm, or less than 0.5 μm.

Step 206 includes de-binding the slurry to remove the binder and solvent. Step 206 may be conducted under heat, vacuum, or heat and vacuum.

In a step 208, the particles are sintered together. The sintering step may remove all or substantially all of remaining binder and/or solvent, leaving only a rigid structure formed of the current collector particles 12, i.e., the anode current collector 10. The sintering step may be conducted in an inert atmosphere, such as a nitrogen or argon atmosphere. In some embodiments, the atmosphere includes at least 4 vol % hydrogen.

In a step 210, the anode current collector 10 formed in step 208 is infiltrated with the anode material to form the hybrid anode 20. The open pore structure of the anode current collector 10 allows the anode material to easily infiltrate and fill void space within the anode current collector 10. The anode material may be as described above. The infiltrating step may be achieved by a variety of techniques. In some embodiments, infiltrating is performed by placing the anode current collector 10 into a mold having smooth walls (with a surface roughness of less than 1 μm) and then using vacuum infiltration with a molten anode material. In other embodiments, the anode material may be deposited into and onto the anode current collector 10 using electroplating or layer by layer deposition, such as spraying. In yet other embodiments, thin sheets of the anode material may be cold pressed into one or both sides of the anode current collector 10. In such embodiments, a soft anode material, such as lithium, will deform into the anode current collector 10 and fill the pores thereof without collapsing the particulate matrix. In some embodiments, a combination of the above techniques is used in the infiltrating step 210. For example, molten anode material may be infiltrated into the anode current collector 10 and then addition anode material may be deposited or pressed onto surfaces of the infiltrated structure.

In some embodiments, step 210 may include intermediate rolling or polishing steps to smooth one or more surfaces of the anode material being infiltrated into the anode current collector 10. In other embodiments, the method 200 includes a smoothing step 212 after the infiltrating step 210, wherein one or more surfaces of the hybrid anode 20 is/are smoothed using, for example, a rolling or polishing technique in order to achieve the surface qualities (uniformity and roughness) described above.

In some embodiments, the method 200 may include a step 214 of forming a battery, such as the battery 100 described above. In step 214, the hybrid anode 20 is assembled with a separator, electrolyte, and cathode (with cathode current collector). These components may be as described above. In some embodiments, the method 200 further includes a step 216 of operating the battery 100 by applying an external electrical load to discharge the battery 100.

As described herein, the hybrid anode 20 is tunable by varying the amount of anode material in either or both of the first anode layer 22 and the second anode layer 24. As such, capacity of the hybrid anode 20 can be accurately adjusted to match that of the cathode 40 in the battery 100. This adjustment can maximize the overall energy density and power density of the battery 100 by not including excess, unusable capacity at the anode or cathode.

Further, due to the unique structure of the hybrid anode 20 disclosed herein, a high amount of contact is achievable between the anode material and anode current collector 10, thereby improving performance of the anode current collector 10. Unlike other methods for increasing contact between the anode material and current collector, the method described herein can avoid to formation of an anode material alloy, which creates further inactive material mass in the battery. Moreover, it has been found that the infiltrated anode material is nearly 100% available for use during discharge of the battery 100. For example, the anode material may have a utilization rate (i.e., anode material accessibility) of greater than 90%, greater than 95%, greater than 99%, or about 100%.

### EXAMPLES

### Example 1

Four hybrid anodes were formed in accordance with the methods described herein with as sintered copper anode current collector and lithium as the anode material. The average density of the porous copper anode current collectors was 3.4 g/cm³, whereas solid copper has a density of 8.96 g/cm³. The anode current collectors were found to have a porosity of about 62%. A discharge capacity of the hybrid anode was determined using electrochemical stripping analysis with a lithium foil counter electrode, a lithium foil reference electrode, and an electrolyte of 0.67 M lithium bis(trifluoromethanesulfonyl)imide (LiFSI). The measured capacity was 3,860 mAh/g of lithium, which is nearly 100% of the theoretical capacity for lithium of 3,862 mAh/g. The results confirmed that nearly all of the lithium in the hybrid anode was available and utilized.

### Example 2

The capacity was calculated for a conventional anode having a solid, 10 μm thick copper foil current collector and 0.18 cm³ of lithium metal as the anode material with about 0.01 cm³ of lithium per cm² of current collector. The capacity was also calculated for a hybrid anode as in Example 1 having the same total thickness as the conventional anode and current collector. The hybrid anode had capacities of 2,950 mAh/g of lithium and copper and 2,025 mAh/cm³ of lithium and copper and the conventional anode had capacities of 2,100 mAh/g of lithium and copper and 1,964 mAh/cm³ of lithium and copper. This represents a 40% increase in specific capacity and a 3% increase in volumetric capacity over the conventional anode of the same thickness.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A battery anode comprising:
a current collector comprising a continuous particulate matrix and an open pore structure; and
an anode material disposed at least within pores of the current collector.

2. The anode of claim 1, wherein the anode material is further disposed as a continuous first layer on a first surface of the current collector and/or a continuous second layer on a second surface of the current collector opposite the first surface.

3. The anode of claim 2, wherein the current collector has a thickness of less than 20 μm; and
wherein a sum of a thickness of the first layer and a thickness of the second layer is from greater than 0 to 200 μm.

4. The anode of claim 3, wherein the thickness of the first layer and/or the second layer has a variation along a length of the anode of less than 2 μm.

5. The anode of claim 3, wherein the anode has a surface roughness of less than 1 μm.

6. The anode of claim 1, wherein the current collector comprises copper and the anode material comprises lithium.

7. The anode of claim 6, wherein the particulate matrix comprises sintered copper particles, the particle having a mean diameter of less than 5 μm.

8. A method comprising:
forming a slurry comprising current collector particles, a binder, and a solvent;
casting the slurry into a film;
de-binding under heat and/or vacuum to remove the binder and solvent;
sintering the current collector particles together to form a current collector comprising a continuous particulate matrix, wherein the particulate matrix comprises an open porous structure; and
infiltrating the current collector with an anode material.

9. The method of claim 8, wherein the current collector particles comprise copper particles having a mean diameter of less than 5 μm.

10. The method of claim 8, wherein infiltrating the current collector comprises vacuum infiltration with molten anode material.

11. The method of claim 10, further comprising rolling the anode to a thickness of less than 220 μm, wherein the thickness has a variation along a length of the anode of less than 2 μm; and
wherein the rolled anode has a surface roughness of less than 1 μm.

12. The method of claim 8, wherein infiltrating the current collector comprises cold pressing the anode material into the current collector from one or both sides of the current collector.

13. The method of claim 12, wherein the anode material comprises lithium.

14. The method of claim 8, wherein infiltrating the current collector forms a continuous layer of the anode material on one or both sides of the current collector; and
wherein the anode has a thickness of from 70 to 120 μm.

15. The method of claim 8, wherein the current collector has a thickness of from 9 to less than 15 μm.

16. The method of claim 8, wherein infiltrating the current collector comprises electroplating.

17. The method of claim 8, wherein infiltrating the current collector comprises layer by layer deposition comprising spraying the anode material.

18. The method of claim 8, wherein infiltrating the current collector completely fills pores of the current collector with the anode material.

19. An anode formed by the method of claim 8.

20. A battery comprising the anode of claim 1, a separator, an electrolyte, and a cathode.
